(19) United States
(12) Patent Application Publication
(10) Pub. No.: US 2013/0332698 A1
(43) Pub. Date: Dec. 12, 2013

(54) DATA PRESERVATION METHOD

(71) Applicant: CHUN-LIN YU, KAOHSIUNG CITY (TW)

(72) Inventor: CHUN-LIN YU, KAOHSIUNG CITY (TW)

(73) Assignee: ASKEY COMPUTER CORP.

(21) Appl. No.: 13/589,291

(22) Filed: Aug. 20, 2012

(30) Foreign Application Priority Data
Jun. 7, 2012 (TW) 101120478

(51) Int. Cl. G06F 12/02

(52) U.S. Cl. 711/173; 711/E12.002

(57) ABSTRACT

A data preservation method applicable to an electronic device operating with an open operating system having a data storage region includes creating a disk partition; creating an authority to access the disk partition and get linked to a group ID (GID); mounting the disk partition in a directory having a user ID (UID) and the GID; and giving authority related to the linked GID to an application having the authority, so as to access data in the disk partition having the GID. The authority, coupled with the GID, allows a specific disk partition to store data generated as a result of execution of the application. Even if the application causes a UID change later for some reason, the application bestowed with the authority can still access data through the GID, thereby preserving data.

### CROSS-REFERENCE TO RELATED APPLICATION

This non-provisional application claims priority under 35 U.S.C. §119(a) on Patent Application No(s). 101120478 filed in Taiwan, R.O.C. on Jun. 7, 2012, the entire contents of which are hereby incorporated by reference.

### FIELD OF TECHNOLOGY

The present invention relates to data preservation methods, and more particularly, to a data preservation method applicable to an electronic device operating with an open operating system.

### BACKGROUND

Due to rapid development of portable electronic devices, such as smartphones, personal digital assistants (PDA), and tablet computers, the data processing performance of the portable electronic devices is ever-increasing. This, coupled with the wide use of mobile communication networks and wireless network environments, makes portable electronic devices a seemingly indispensable digital-era assistant to people nowadays.

An open operating system, such as Android, is an operating system in wide use with an electronic device. The Android operating system provides a “factory reset” function for erasing data from a data partition and a cache partition. The aforesaid function can erase a user-installed application. Although applications built in the Android operating system cannot be uninstalled, various data related to the applications are erased by the factory reset function. For example, upon execution of the factory reset function by the Android operating system, any data generated in the course of the execution of the aforesaid applications, settings related to the applications, and any data related to user IDs of the applications (such as user IDs (UID) in Linux) are erased, whether the applications are built in the operating system or installed by the users. Furthermore, reinstallation of the applications is often followed by allocation of new user IDs (such as group IDs (GID) in Linux); as a result, due to a change of a user ID, not only is it impossible to access a previous execution course of the application with the authority of the UID, but it is also impossible to access (previously-created) data in any unerased disk partition with the authority of the UID.

A conventional data recovery method based on a data backup function intrinsically provided by the Android operating system involves performing data backup by means of a cloud system, wherein, to enable an application to be updated by a user, application-related data are sent to a remote server via a network and stored on the remote server in advance, such that the data thus stored can be retrieved from the remote server whenever the user reinstalls the application after having removed the application or used the factory reset function. However, the method has its own drawbacks. For example, inapplicability of the method in the course of execution of an application, failure to access data on a remote server freely, and necessity of a network; hence, the method lacks ease of use.

### SUMMARY

It is an objective of the present invention to prevent data loss which might otherwise occur as a result of the updating of a system or the execution of the factory reset function.

Another objective of the present invention is to provide a data preservation method effective in preserving data in real time and conducive to ease of use.

In order to achieve the above and other objectives, the present invention provides a data preservation method applicable to an electronic device operating with an open operating system, the electronic device having a data storage region, the data preservation method comprising the steps of: creating a disk partition in the data storage region; creating an authority to access the disk partition and get linked to a group ID (GID); mounting the disk partition in a directory having a user ID (UID) and the GID; and giving the authority to an application, such that the application having the authority accesses data in the disk partition having the GID.

In an embodiment, the step of mounting the disk partition in the directory having the UID and the GID further comprises the sub-steps of: mounting the disk partition in the directory; configuring the UID and the GID of the directory; and configuring UID authority and GID authority pertaining to all subdirectories and files in the directory.

In an embodiment, the method further comprises the steps of: performing a reset process of the open operating system; reinstalling the application; and giving the authority to the application, such that the application declares the authority thereof and therefore reads from the disk partition any data in the directory having the GID.

In an embodiment, the open operating system is an Android operating system.

In order to achieve the above and other objectives, the present invention further provides a computer program product for executing the aforesaid method after being mounted on an electronic device.

Accordingly, due to the collaborative use of the authority and the GID, not only can data generated in the course of the execution of the application be stored in a specific disk partition, but the data can also be accessed by any application endowed with the authority by means of the GID, thereby preserving the data. The data can be recovered easily by allowing the reinstalled application to fetch the previously-created data by means of the authority-linked GID.

### BRIEF DESCRIPTION OF THE DRAWINGS

Objectives, features, and advantages of the present invention are hereunder illustrated with specific embodiments in conjunction with the accompanying drawings, in which:

FIG. 1 is a flow chart of a data preservation method according to an embodiment of the present invention;

FIG. 2 is a flow chart of the step of mounting the disk partition in a directory having a user ID and a group ID according to an embodiment of the present invention;

FIG. 3 is a flow chart of a reset process performed with the data preservation method according to an embodiment of the present invention; and

FIG. 4 is a schematic view of a result of application of the data preservation method according to an embodiment of the present invention.

### DETAILED DESCRIPTION

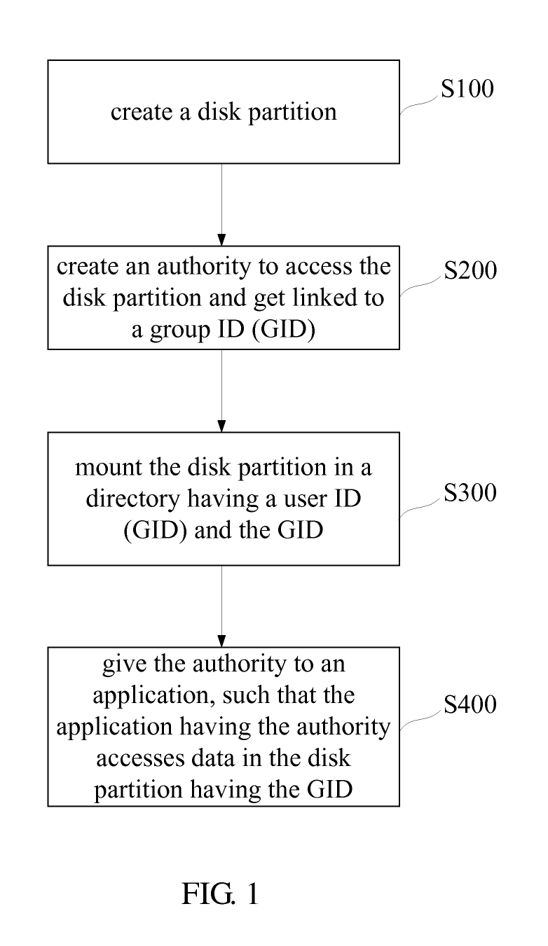

Referring to FIG. 1, there is shown a flow chart of a data preservation method according to an embodiment of the present invention. In an embodiment of the present invention, the data preservation method is applicable to an electronic device operating with an open operating system. The electronic device has a data storage region. The data storage region is located at a partition different from the system partition that stores the open operating system. The electronic device is exemplified by a smartphone, a personal digital assistant (PDA), or a tablet computer. For example, the open operating system is an Android operating system.

In an embodiment of the present invention, the data preservation method comprises the steps of:

Step S100: creating a disk partition, wherein the disk partition is located at the data storage region.

Step S200: creating an authority to access the disk partition and get linked to a group ID (GID). For example, the related command for use in the Android operating system is as follows:

create a declaration of an authority in
mydroid/frameworks/base/core/res/AndroidManifest.xml as follows:

<permission android:name=”com.askey.permission.PRIVATE”
android:protectionLevel=”signatureOrSystem” />

For example, the command for use in the Android operating system to link the new authority and a group id (id=askey) is as follows:

create a declaration in mydroid/frameworks/base/data/etc/platform.xml as
follows:

<permission name=”com.askey.permission.PRIVATE”>
<group id= “askey” />
</permission>

Step S300: mounting the disk partition in a directory having a user ID (UID) and the GID.

Step S400: giving the authority to an application, such that the application having the authority accesses data in the disk partition having the GID. For example, the related command for use in the Android operating system is as follows:

To access the application of the data preservation method, it is necessary to add a declaration of the authority used (see below) to its AndroidManifest.xml so as to acquire the authority of “askey group”.

<uses-permission android:name=“com.askey.permission.PRIVATE”/>

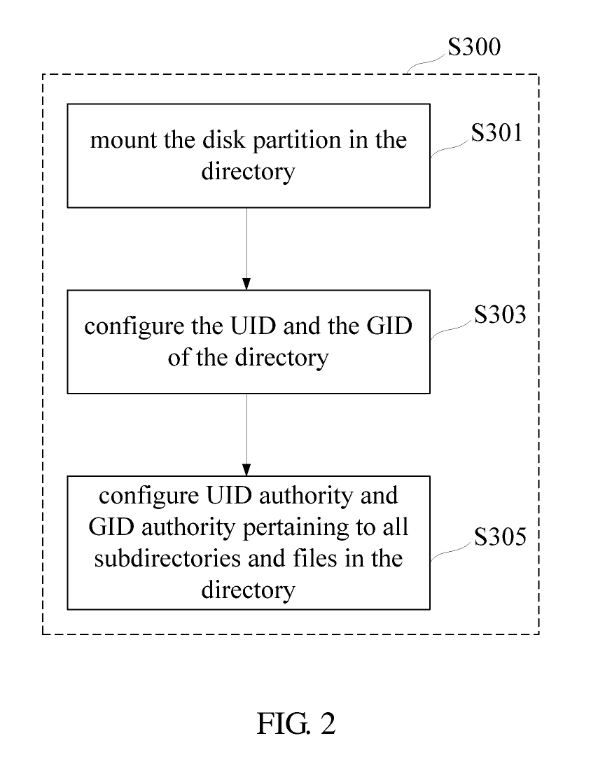

Referring to FIG. 2, in an embodiment, the step of mounting the disk partition in the directory having the UID and the GID further comprises:

Step S301: mounting the disk partition in the directory. For example, the related command for use in the Android operating system is as follows:

Mount ext4 /dev/block/platform/mmci-omap-hs. 1/by-name/askey /askey
wait noatime
nosuid nodev

Step S303: configuring the UID and the GID of the directory. For example, the related command for use in the Android operating system is as follows:

chown system askey/askey

Step S305: configuring UID authority and GID authority pertaining to all subdirectories and files in the directory. For example, the related command for use in the Android operating system is as follows:

chmod_r 2770/askey

The purposes of step S301 and step S303 are to prevent data from being fully disclosed and prevent any unauthorized application from seeing or accessing the hidden disk partition (i.e., the disk partition created in step 100.)

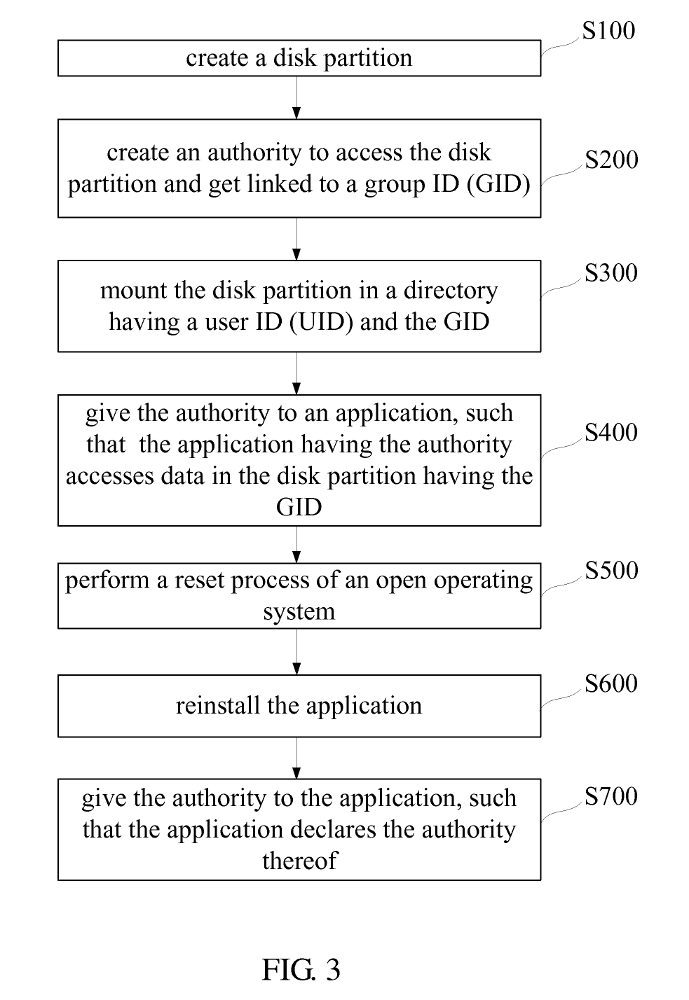

Referring to FIG. 3, there is shown a flow chart of a reset process performed with the data preservation method according to an embodiment of the present invention. As shown in FIG. 3, step S400 is followed by:

Step S500: performing a reset process of the open operating system. The reset process entails resetting the operating system, removing an application, and replacing an electronic device (including system transplant and transfer.)

Step S600: reinstalling the application.

Step S700: giving the authority to the application, such that the application declares the authority thereof and therefore reads from the disk partition any data in the directory having the GID.

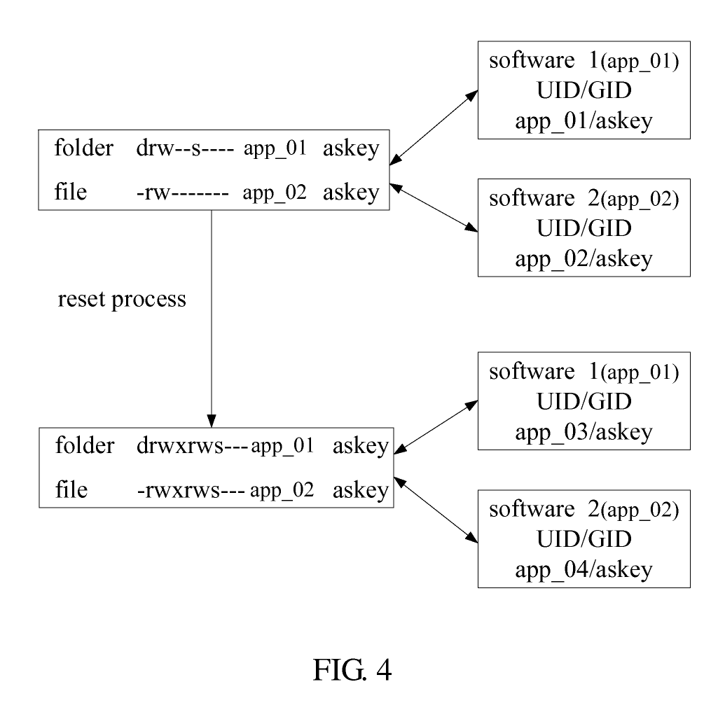

Referring to FIG. 4, there is shown a schematic view of a result of application of the data preservation method according to an embodiment of the present invention. As shown in the diagram, upon completion of the reset process of the open operating system, all the UID “app_x” initially used by application “software 1, software 2” has been allocated by the system anew; the application is unable to access the data generated in the aforesaid process again, when using the UID only and not using the method of the present invention. For example, upon completion of the reset process, the UID has changed, and thus software 1 is unable to access the folder “drw--s----” previously created, whereas software 2 is unable to access the file “-rw-------” previously created, because its authority is configured to be able to read and write only when the UIDs are identical.

A drawback of the method according to an embodiment of the present invention is that, given a declaration of the authority, GID-based recognition allows a reinstalled application to access the disk partition for previously-created data by means of the GID. That is to say, even if a UID changes, an application can access a file by means of the GID. Referring to FIG. 3, given an authority acquired through a GID code “askey”, it is feasible to access data previously stored by software 1 and software 2, and data thus created can be attributed to an identical GID code “askey”.

In another embodiment of the present invention, upon completion of the reset process of the open operating system, a program product capable of performing the method of FIG. 3 is mounted in order to search and find previously-created data and access the data.

In conclusion, given the joint use of the authority and the GID, data created in the course of an execution process of an application can be easily preserved and read as soon as a reset process is performed and finished, thereby preventing the data from vanishing.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A data preservation method applicable to an electronic device operating with an open operating system, the electronic device having a data storage region, the data preservation method comprising the steps of:
creating a disk partition in the data storage region;
creating an authority to access the disk partition and get linked to a group ID (GID);
mounting the disk partition in a directory having a user ID (UID) and the GID; and
giving the authority to an application, such that the application having the authority accesses data in the disk partition having the GID.

2. The method of claim 1, wherein the step of mounting the disk partition in the directory having the UID and the GID further comprises the sub-steps of:
mounting the disk partition in the directory;
configuring the UID and the GID of the directory; and
configuring UID authority and GID authority pertaining to all subdirectories and files in the directory.

3. The method of claim 1, further comprising the steps of:
performing a reset process of the open operating system;
reinstalling the application; and
giving the authority to the application, such that the application declares the authority thereof and therefore reads from the disk partition any data in the directory having the GID.

4. The method of claim 3, wherein the reset process executes a factory reset function.

5. The method of claim 1, wherein the open operating system is an Android operating system.

6. A data preservation method applicable to an electronic device operating with an open operating system, the electronic device having a data storage region housing a disk partition, wherein an application accessing the disk partition has an authority to store data in a directory having a user ID (UID) and a group ID (GID), the data preservation method comprising the steps of:
executing a factory reset function of the open operating system;
reinstalling the application; and
giving the authority to the application, such that the application declares the authority thereof and therefore reads from the disk partition any data in the directory having the GID.

7. The method of claim 6, wherein the open operating system is an Android operating system.

8. A computer program product for executing the method of claim 6 after being mounted on an electronic device.
